(19) United States
(12) Patent Application Publication
(10) Pub. No.: US 2025/0130745 A1
(43) Pub. Date: Apr. 24, 2025

(54) PRINTING DEVICE CONSUMABLE ITEM HAVING OPTICALLY SCANNABLE AUTHORIZATION CODE AND ELECTRICALLY READABLE AUTHORIZATION CODE

(71) Applicant: Hewlett-Packard Development Company, L.P., Spring, TX (US)

(72) Inventors: Gabriel Scott McDaniel, Boise, ID (US); Miguel Angel De Anda, Boise, ID (US); Juan Guzman, Boise, ID (US)

(21) Appl. No.: 18/832,974

(22) PCT Filed: Jan. 28, 2022
(86) PCT No.: PCT/US2022/014208

§ 371 Date: Jul. 25, 2024

(51) Int. Cl. G06F 3/12

(52) U.S. Cl. CPC G06F 3/1239; G06F 3/1222; G06F 3/1238; G06F 3/1285

(57) ABSTRACT

A first authorization code on a consumable item for a printing device is optically scanned. A second authorization code on the consumable item is electrically read by the printing device upon the insertion of the consumable item into the printing device. In response to determining that the first and second authorization codes match, the printing device is authorized to use the consumable item for printing.

### BACKGROUND

Printing devices can use a variety of different technologies to form images on media such as paper or to build three-dimensional (3D) objects. Such technologies include dry electrophotography (EP) and liquid EP (LEP) technologies, which may be considered as different types of laser and light-emitting diode (LED) printing technologies, as well as inkjet-printing technologies and three-dimensional (3D) printing technologies. Printing devices deposit print material, such as colorant like toner, ink (which can include other printing fluids or material as well), or 3D print material.

### BRIEF DESCRIPTION OF THE DRAWINGS

FIG. 1A is a diagram of an example printing device consumable item having both an optically scannable authorization code and an electrically readable authorization code.

FIG. 1B is a block diagram of an example printing device.

FIG. 2 is a diagram of an example system including an example printing device, and that can also include a server computing device and/or one or two client computing devices.

FIGS. 3A, 3B, 3C, 3D, 3E, and 3F are flowcharts of example methods for authorizing usage of a consumable item within a printing device based on optically scannable and electrically readable authorization codes of the consumable item, where a computing device determines whether the authorization codes match.

FIGS. 4A and 4B are flowcharts of example methods for authorizing usage of a consumable item within a printing device based on optically scannable and electrically readable authorization codes of the consumable item, where the printing device determines whether the authorization codes match.

FIG. 5 is a diagram of an example non-transitory computer-readable data storage medium storing program code that is executable to authorize usage of a consumable item within a printing device based on optically scannable and electrically readable authorization codes of the consumable item.

### DETAILED DESCRIPTION

As noted in the background, printing devices deposit print material to form images on media or, in the case of three-dimensional (3D) printing devices, to additively build (3D) objects. A printing device can include a cartridge of print material that the device uses for printing. As the printing device prints print jobs, print material is consumed from the cartridge. When the cartridge is empty or is running low on print material, the cartridge may be replaced with a replacement cartridge that has a fresh (e.g., full) supply of print material. A cartridge is thus one type of a consumable item that a printing device uses for printing. Other examples include fuser assemblies, developer assemblies, and so on, in the case of a laser-printing device, and fluid-ejection (e.g., inkjet) printheads in the case of a fluid-ejection (e.g., inkjet) device that employs separately replaceable printheads and fluid (e.g., ink) supplies.

To ensure that printing devices print with the best image and print quality possible, manufacturers advise users that they should use authorized consumable items within the printing devices. An authorized consumable item can be one that is manufactured by or for the manufacturer of a printing device and acquired from a trusted party. A user purchasing such a consumable item can therefore be certain that usage of the item within his or her printing device will result in the best performance possible, and will not damage the device.

A consumable item that is manufactured by or for the manufacturer is an authentic consumable item. Acquisition of the item from a trusted party ensures that the item has not been impermissibly modified or reused, such as by being refilled with unauthorized toner, by an unauthorized party. That is, an otherwise authentic consumable item that is impermissibly refilled with unauthorized toner can result in degraded image and print quality, and potentially damage the printing device, when reused in this manner. Acquisition from a trusted party further ensures that a counterfeit consumable item will not be passed off as authentic.

To guard against unauthorized consumable items from being unknowingly used in printing devices, authentic consumable items may include authorization codes of varying sophistication by which the items can be verified as indeed being authentic. In certain cases, a printing device may prevent a consumable item that fails authentication from being used, for instance, to prevent possible damage to the device, or for other reasons. In certain other cases, instead of preventing use of the consumable item, the printing device may change operating parameters to a different mode to reduce the likelihood of device damage.

Such authorization codes can be in the form of security-hardened authentication integrated circuits (ICs), radio frequency identifier (RFID) and near-field communication (NFC) tags, or other electrically readable codes that contain information which can be authenticated by the printing devices, potentially in communication with a computing device operated by the manufacturer. Other authorization codes can be in the form of quick response (QR) codes, other types of two-dimensional and one-dimensional barcodes, or other optically scannable codes. In this case, a consumable item is authorized for usage within a printing device if the authorization code on or of the item is successfully verified.

However, remanufacturers, counterfeiters, and other unauthorized third parties have been known to remove authorization codes from authentic consumable items for reuse on impermissibly remanufactured or refilled, counterfeit, or other unauthorized consumable items. An unsuspecting end user may thus purchase or acquire such an unauthorized consumable item for usage in his or her printing device. Because the authorization code on the consumable item is authentic, it may be pass verification and thus authorize usage of the consumable item within the device. Because the consumable item is not in actuality authentic—or is authentic but has been impermissibly refilled or remanufactured—the printing device may not print as well using the item, and indeed may become damaged as a resulting of usage of the consumable item.

Techniques described herein ameliorate these and other issues by including two authorization codes on a printing device consumable item. Specifically, a consumable item for a printing device includes both an electrically readable authorization code and an optically scannable authorization code. For the printing device to be authorized to use the consumable item, the two authorization codes have to match. The techniques therefore lessen the likelihood that authorization codes are reused on unauthorized consumable items.

For example, an unauthorized third party may be easily able to remove one but not both of the authorization codes from an authentic consumable item. Therefore, reuse of the removed authorization code on an unauthorized consumable item will not result in the consumable item being authorized for usage, because the other authorization code is missing. Even if the third party is able to make a replica of the missing authorization code for inclusion on the consumable item, the replica is unlikely to match the other authorization code, such that the item will still not be authorized for usage within a printing device.

As another example, an unauthorized third party may be able to remove both authorization codes from an authentication consumable item. However, in this case, the third party has to painstakingly maintain matching authorization code pairs. For instance, if the third party reuses the optically scannable authorization code from a first authentic consumable item and the electrically readable authorization code from a second authentic consumable item on an unauthorized consumable item, the two codes will not match. Therefore, the consumable item will still not be authorized for usage within a printing device.

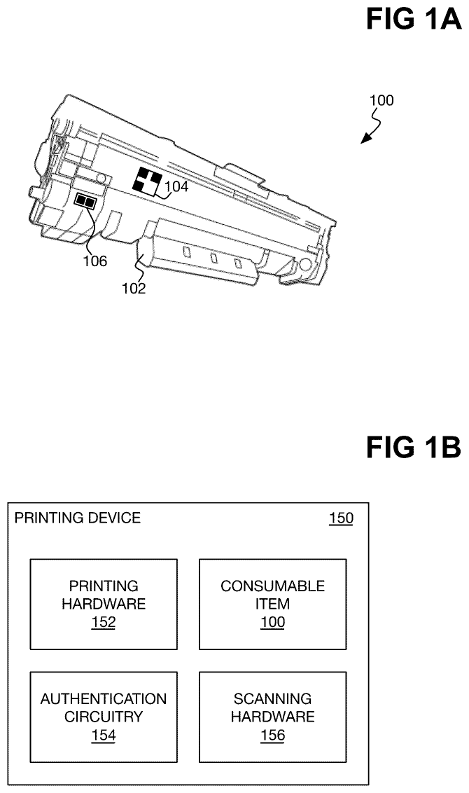

FIG. 1A shows an example printing device consumable item 100. In the example, the consumable item 100 is a toner cartridge for usage within a laser printing device. The consumable item 100 can instead be a different type of item including a supply of colorant, such as an inkjet cartridge for usage within an inkjet printing device. The consumable item 100 can instead be a different type of item other than one including a supply of colorant.

The consumable item 100 includes a housing 102, an optically scannable first authorization code 104, and an electrically readable second authorization code 106. The optically scannable first authorization code 104 may be a QR code, another type of two-dimensional or one-dimensional barcode, and so on. The authorization code 104 may be etched into the exterior of the housing 102 of the consumable item 100, or may be printed on a label that is affixed to the exterior of the housing 102.

The electrically readable second authorization code 106 may be a security-hardened authentication IC, a RFID or NFC tags, and so on. In the example, the authorization code 106 is attached to the exterior of the housing 102 of the consumable item 100. However, in another implementation, the authorization code 106 may be attached to an interior of the housing 102 or implanted within the housing 102 itself, such that the authorization code 106 is hidden from view at the exterior of the housing 102.

The authorization codes 104 and 106 match. That is, the information stored by the code 104 matches the information stored by the code 106. For example, the authorization codes 104 and 106 may store the same information, or may store information that has been linked as corresponding to (and thus matching) one another within a database. The authorization codes 104 and 106 may encrypted or unencrypted, and may be digitally signed or not digitally signed.

For example, the authorization codes 104 and 106 may either or both be encrypted using a symmetric cryptographic key included within the secure hardware of printing devices manufactured to use the consumable item 100, and/or maintained privately at or on behalf of the manufacturer of the printing devices. The cryptographic key is not publicly accessible, and is used by a printing device or by or on behalf of the manufacturer to decrypt the authorization codes 104 and 106. If after decryption the codes 104 and 106 match, then usage of the consumable item 100 is authorized.

As another example, in addition or instead, the authorization codes 104 may be digitally signed with a private cryptographic key of an asymmetric public-private key pair of the manufacturer of the printing device. The printing device or a computing device can use the public cryptographic key of the key pair to ascertain that the authorization codes 104 and 106 have originated from the manufacturer. If the authorization codes 104 and 106 have been verified as having originated from the manufacturer, and the codes 104 and 106 match, then usage of the consumable item 100 is authorized.

FIG. 1B shows an example printing device 150 that can removably include the consumable item 100 and use the item 100 for printing. The printing device 150 may be a standalone printer, or an all-in-one (AIO) device or a multifunction device (MFD). As to the latter, the printing device 150 may include other functionality in addition to printing functionality, such as scanning, copying, and/or faxing functionality, for instance.

The printing device 150 includes printing hardware 152. The printing hardware 152 includes the electrical and electronic circuitry as well as the mechanical components by which the device 150 uses the consumable item 100 for printing. For example, in the case of a laser printing device 150, the printing hardware 152 is laser printing hardware 152, whereas in the case of an inkjet printing device 150, the printing hardware 152 is inkjet printing hardware 152.

The printing device 150 includes authentication circuitry 154. The authentication circuitry 154 may be considered as including a processor and memory. The processor and memory may be integrated within an application-specific integrated circuit (ASIC) in the case in which the processor is a special-purpose processor. The processor may instead be a general-purpose processor, such as a central processing unit (CPU), in which case the memory may be a separate semiconductor or other type of volatile or non-volatile memory.

The authentication circuitry 154 may be security-hardened, such that it is securely isolated from components of the printing device 150 external to the circuitry 154. The authentication circuitry 154 may be security-hardened particularly in the case in which the circuitry 154 stores cryptographic keys that are not intended to be publicly available or used outside of the printing device 150. In another implementation, the authentication circuitry 154 may not be security-hardened, such as in the case in which the circuitry 154 does not store such cryptographic keys. The authentication circuitry 154 can electrically read the electrically readable second authorization code 106 when the consumable item 100 has been inserted in the printing device 150.

The printing device 150 may include scanning hardware 156 if the device 150 is an AIO device or an MFD. The scanning hardware 156 may be optical scanning hardware, and include the electronic and electrical circuitry, optical components, and mechanical components to optically scan a digital image from a real-world, physical image. For instance, the scanning hardware 156 may be in the form of a flatbed scanner having a transparent (e.g., glass) plate, such that the hardware 156 is able to optically scan a digital image from objects placed on the transparent plate.

The scanning hardware 156 may be charge-coupled device (CCD) or contact-image scanner (CIS) scanning hardware 156, among other types of scanning hardware. The inventors have in particularly novelly identified that CCD scanning hardware 156 of a printing device 150 that is an AIO device or an MFD, which is designed to scan digital images from images printed on print media such as paper, can also be used to accurately optically scan the optically scannable first authorization code 104 from the consumable item 100. Prior to insertion of the consumable item 100 within the printing device 150 for usage for printing (or upon removal of the item 100 from the device 150 if already inserted), the consumable item 100 can be placed on the transparent plate of the scanning hardware 156 to optically scan the authorization code 104.

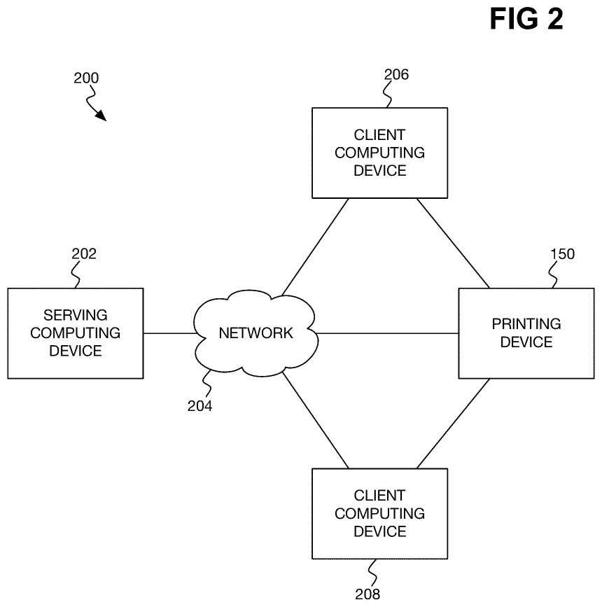

FIG. 2 shows an example system 200 including the printing device 150. The system 200 can also include a server computing device 202 operated by or on behalf of the manufacturer of the printing device 150 and/or the consumable item 100. The service computing device 202 may provide a cloud computing service, for instance, and be communicatively connected to a network 204, which may be or include the Internet. The printing device 150 may also be communicatively connected to the network 204.

The system 200, in addition to or in lieu of the server computing device 202, can include a client computing device 206 and/or a client computing device 208. The computing devices 206 and 208 may be desktop, laptop, or notebook computers, for instance, smartphones, tablet computing devices, or other types of computing devices. The computing devices 206 and 208 may be devices at the same physical location as the printing device 150, and/or may belong to or operated by or for the user of the printing device 150.

The client computing devices 206 and 208 may each be communicatively connected to the network 204. In addition or instead, the computing devices 206 and 208 may each be more directly connected to the printing device 150. For example, the computing devices 206 and 208 may each be directly connected to the printing device 150 via a wired cable directly interconnecting the two, such as a universal bus cable (USB), or via a direct wireless interconnection, such as using a peer-to-peer Bluetooth connection, an NFC connection, a Wi-Fi Direction connection, or an ad hoc Wi-Fi network. As another example, the computing devices 206 and 208 may each be connected to the printing device 150 via a network other than or in addition to the network 204, such as a wired or wireless local-area network (LAN).

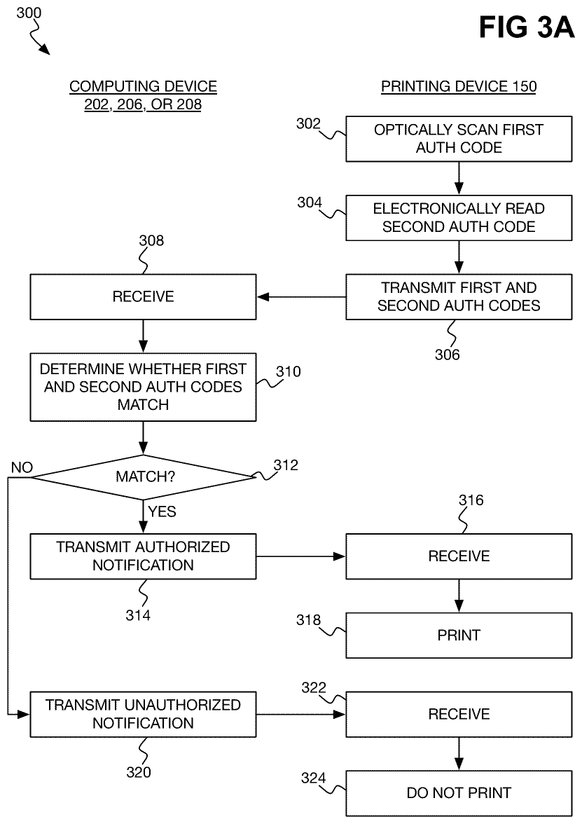

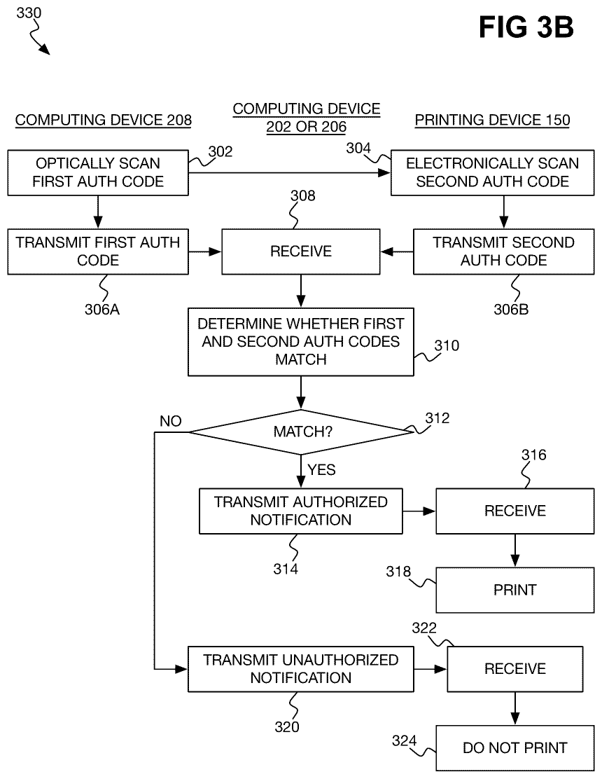

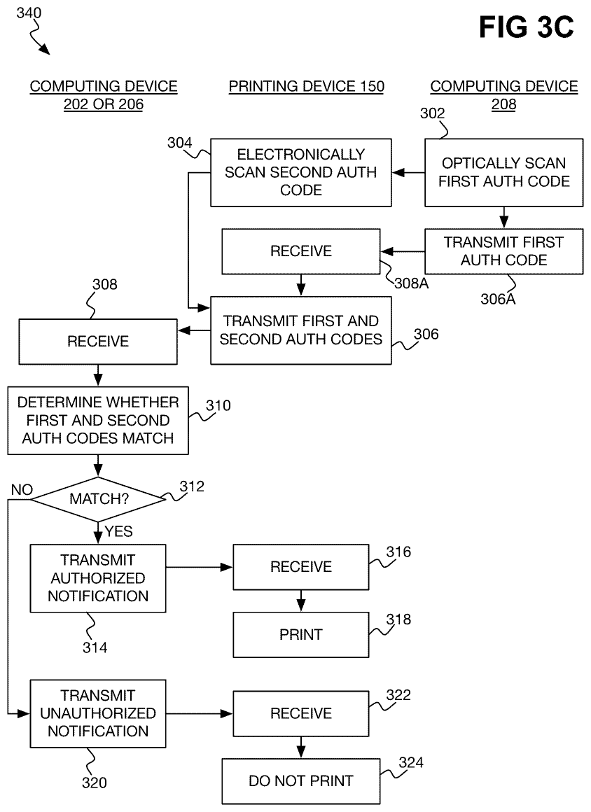

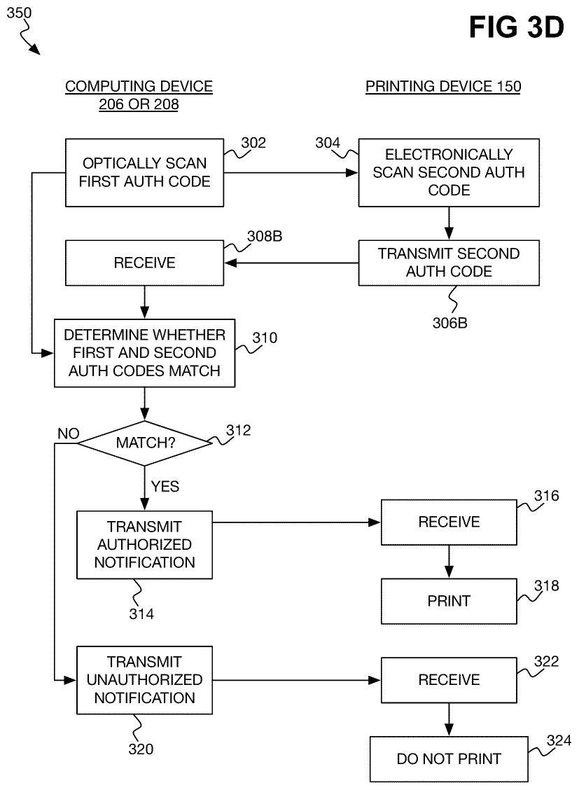

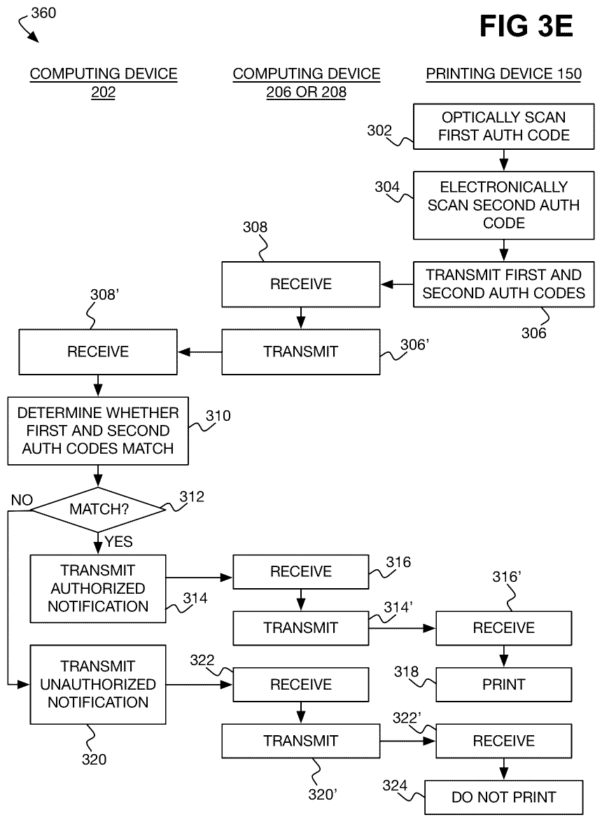

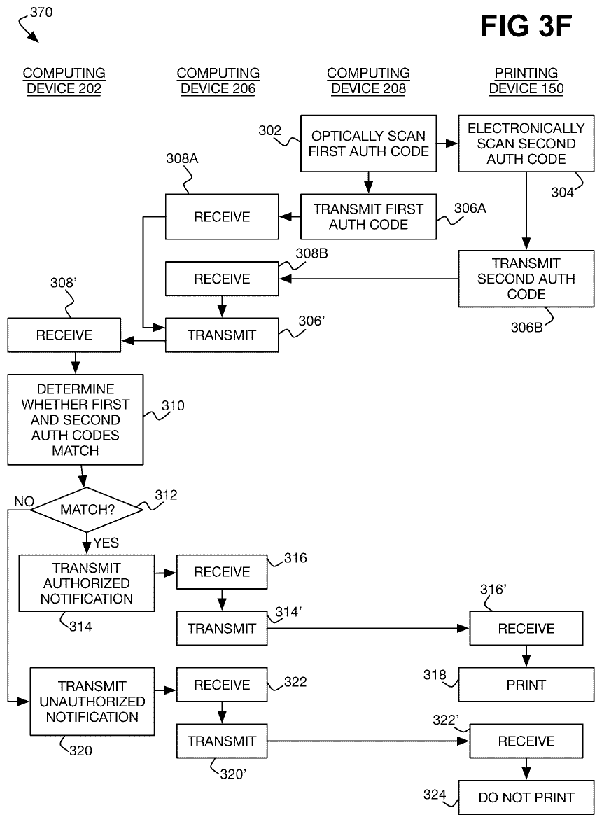

FIGS. 3A, 3B, 3C, 3D, 3E, and 3F respectively show example methods 300, 330, 340, 350, 360, and 370 for authorizing usage of the consumable item 100 within the printing device 150. Such usage authorization is based on the optically scannable first authorization code 104 and the electrically readable second authorization code 106 of the consumable item 100. In the methods 300, 330, 340, 350, 360, the computing device 202, 206, or 208, as opposed to the printing device 150, determines whether the authorization codes 104 and 106 match in this respect.

Referring first to FIG. 3A, the method 300 pertains to an example in which the printing device 150 both optically scans the optically scannable first authorization code 104 and electrically reads the electrically readable second authorization code 106. The method 300 thus pertains to an implementation in which the printing device 150 is an AIO device or an MFD, and has the scanning hardware 156. Furthermore, in the example of FIG. 3A, the computing device 202, 206, or 208 determines whether the codes 104 and 106 match.

Prior to insertion of the consumable item 100 into the printing device 150, the item 100 is placed on the transparent plate of the scanning hardware 156, and the hardware 156 optically scans the optically scannable first authorization code 104 (302). If the consumable item 100 has already been inserted into the printing device 150, the item 100 is instead removed and placed on the transparent plate so that the scanning hardware 156 can optically scan the authorization code 104. Upon insertion of the consumable item 100 into the printing device 150, the authentication circuitry 154 electrically reads the electrically readable second authorization code 106 (304).

The printing device 150 transmits the first and second authorization codes 304 and 306 to the computing device 202, 206, or 208 (306), which receives the authorization codes 304 and 306 (308). In the case of the computing device 202, the printing device 150 transmits the authorization codes 304 and 306 over the network 204 to the computing device 202. In the case of the computing device 206 or 208, the printing device 150 can transmit the authorization codes 304 and 306 over the network 204 or more directly to the computing device 206 or 208.

The computing device 202, 206, or 208 determines whether the first and second authorization codes 304 and 306 match (310). In the case of the computing device 202, the computing device 202 may first decrypt the authorization codes 304 and 306 using a symmetric cryptographic key that was used to encrypt the codes 304 and 306 and that is available just to the manufacturer or the authorized party operating the computing device 202. The computing device 202 may then determine whether the authorization codes 304 and 306 are identical. The computing device 202 may look up the authentication codes 304 and 306 within a database to determine whether the codes 304 and 306 have been corresponded to one another as a matching pair, where the codes 304 and 306 were previously stored as a matching pair.

In the case of the computing device 206 or 208, the computing device 206 or 208 may first verify that the first and second authorization codes 304 and 306 were digitally signed with a private cryptographic key of an asymmetric public-private key pair by or on behalf of the manufacturer that securely maintains the private key. That is, the computing device 206 or 208 may use the public cryptographic key of this key pair to verify that the authorization codes 304 and 306 have been signed with the private cryptographic key. The computing device 206 or 208 may then determine whether the authorization codes 304 and 306 are identical.

If the first and second authorization codes 304 and 306 match (312), the computing device 202, 206, or 208 transmits to the printing device 150 an authorized notification authorizing use of the consumable item 100 within the device 150 (314). The printing device 150 receives the authorized notification (316), and therefore is permitted to and subsequently does print using the consumable item 100 (318). However, if the authorization codes 304 and 306 do not match (312), the computing device 202, 206, or 208 transmits to the printing device 150 an unauthorized notification prohibiting use of the consumable item 100 within the device 150 (320). The printing device 150 receives the unauthorized notification (322), and therefore is prohibited from and subsequently refrains from printing using the consumable item 100 (324). That is, the printing device 150 does not print using the consumable item 100.

Referring next to FIG. 3B, the method 330 pertains to an example in which the printing device 150 electrically reads the electrically readable second authorization code 106 and the computing device 208 optically scans the optically scannable first authorization code 104. The method 330 thus can pertain to an implementation in which the printing device 150 may be a standalone printer. Furthermore, in the example of FIG. 3B, the computing device 202 or 206 (i.e., not the computing device 208) determines whether the codes 104 and 106 match.

Prior to insertion of the consumable item 100 into the printing device 150, the computing device 208 optically scans the optically scannable first authorization code 104 (302). For example, the computing device 208 may be a scanning device, such as a standalone scanner, communicatively connected to the computing device 202 or 206. As another example, the computing device 208 may be a digital camera, may include or have a webcam, or may be a device like a smartphone or tablet computing device that has an image-capturing sensor. If the consumable item 100 has already been inserted into the printing device 150, the item 100 may be at least partially removed from the device 150 so that the computing device 208 can optically scan the first authorization code 104.

Upon insertion of the consumable item 100 into the printing device 150, the authentication circuitry 154 electrically reads the electrically readable second authorization code 106 (304). The computing device 208 transmits the first authorization code 104 to the computing device 202 or 206 (306A), and the printing device 150 transmits the second authorization code 106 to the computing device 202 or 206 (306B). The computing device 202 or 206 determines whether the authorization codes 104 and 106 match (310), as has been described.

As has also been described, if the first and second authorization codes 104 and 106 match (312), the computing device 202 or 206 transmits to the printing device 150 an authorized notification (314). The printing device 150 receives the authorized notification (316) and can subsequently print using the consumable item 100 (318). If the authorization codes 104 and 106 do not match (314), the computing device 202 or 206 transmits an unauthorized notification to the printing device 150 (320), which receives the unauthorized notification (322) and subsequently does not print using the consumable item 100 (324).

Referring next to FIG. 3C, the method 340 similarly pertains to an example in which the printing device 150 electrically reads the electrically readable second authorization code 106 and the computing device 208 optically scans the optically scannable first authorization code 104. In the example of FIG. 3C, the computing device 202 or 206 (i.e., not the computing device 208) similarly determines whether the codes 104 and 106 match. However, unlike in the prior example, in the example of FIG. 3C, the computing device 202 or 206 receives the first authorization code 104 from the printing device 150, and not from the computing device 208.

The computing device 208 optically scans the optically scannable first authorization code 104 (302) as before, and the printing device 150 electrically reads the electrically readable second authorization code 106 (304). The computing device 208 transmits the first authorization code 104 to the printing device 150 (306A), which receives the authorization code 104 (308A). The printing device then transmits both authorization codes 104 and 106 to the computing device 202 or 206 (306), which receives the codes 104 and 106 (308). The computing device 202 or 206 determines whether the authorization codes 104 and 106 match (310), as has been described.

As has also been described, if the first and second authorization codes 104 and 106 match (312), the computing device 202 or 206 transmits to the printing device 150 an authorized notification (314). The printing device 150 receives the authorized notification (316) and can subsequently print using the consumable item 100 (318). If the authorization codes 104 and 106 do not match (314), the computing device 202 or 206 transmits an unauthorized notification to the printing device 150 (320), which receives the unauthorized notification (322) and subsequently does not print using the consumable item 100 (324).

Referring next to FIG. 3D, the method 350 pertains to an example in which the printing device 150 electrically reads the electrically readable second authorization code 106 and the computing device 206 or 208 optically scans the optically scannable first authorization code 104. In the example of FIG. 3C, this same computing device 206 or 208 also determines whether the codes 104 and 106 match. That is, a computing device (e.g., computing device 202) other than the computing device 206 or 208 that optically scanned the authorization code 104 does not determine whether the codes 104 and 106 match.

The computing device 206 or 208 optically scans the optically scannable first authorization code 104 (302), as has been described in relation to the computing device 208, and the printing device 150 electrically reads the electrically readable second authorization code 106 (304). The printing device 150 transmits the second authorization code 106 to the computing device 206 or 208 (306B), which receives the authorization code 106 (308B). The computing device 206 or 208 then determines whether the authorization codes 104 and 106 match (310), as has been described.

As has also been described, if the first and second authorization codes 104 and 106 match (312), the computing device 206 or 208 transmits to the printing device 150 an authorized notification (314). The printing device 150 receives the authorized notification (316) and can subsequently print using the consumable item 100 (318). If the authorization codes 104 and 106 do not match (314), the computing device 206 or 208 transmits an unauthorized notification to the printing device 150 (320), which receives the unauthorized notification (322) and subsequently does not print using the consumable item 100 (324).

Referring next to FIG. 3E, the method 360 pertains to an example in which the printing device 150 both optically scans the optically scannable first authorization code 104 and electrically reads the electrically readable second authorization code 106. However, the computing device 206 or 208 transmits the first and second authorization codes 104 and 106 on behalf of (i.e., as a proxy of) the printing device 150 to the computing device 202, which determines whether the codes 104 and 106 match. The method 360 thus can pertain to an implementation in which the printing device 150 may not be connected to the computing device 202 over the network 204.

The printing device 150 optically scans the optically scannable first authorization code 104 (302) and electrically reads the electrically readable second authorization code 106 (304), as has been described. The printing device 150 transmits the first and second authorization codes 104 and 106 to the computing device 206 or 208 (306), which receives the authorization codes 104 and 106. The computing device 206 or 208 in turn transmits the codes 104 and 106 to the computing device 202 (306′), which likewise receives them (308′). The computing device 202 then determines whether the authorization codes 104 and 106 match (310), as has been described.

If the first and second authorization codes 104 and 106 match (312), the computing device 202 transmits an authorized notification to the computing device 206 or 208 (314), which receives the notification (316). The computing device 206 or 208 in turn transmits the notification to the printing device 150 (314′), which receives it (316′) and can subsequently print using the consumable item 100 (318). If the authorization codes 104 and 106 do not match (314), the computing device 202 transmits an unauthorized notification to the computing device 206 or 208 (320), which receives the notification (322). The computing device 206 or 208 in turn transmits the notification to the printing device 150 (320′), which receives it (322′) and subsequently does not print using the consumable item 100 (324).

Referring finally to FIG. 3F, the method 370 similarly pertains to an example in which the printing device 150 electrically reads the electrically readable second authorization code 106, and the computing device 206 transmits the first and second authorization codes 104 and 106 on behalf of the printing device 150 to the computing device 202, which determines whether the codes 104 and 106 match. However, unlike in the prior example, in the example of FIG. 3F, the computing device 208 optically scans the optically scannable first authorization code 104 and transmits the code 104 to the computing device 206 for transmission to the computing device 202.

The computing device 208 optically scans the optically scannable first authorization code 104 (302), and the printing device 150 electronically reads the electrically readable second authorization code 106 (304), as has been described. The computing device 208 and the printing device 150 respectively transmit the first and second authorization codes 104 and 106 to the computing device 206 (306A, 306B), which receives the codes 104 and 106 (308A, 308B). The computing device 206 in turns transmits both the authorization codes 104 and 106 to the computing device 202 (306′), which receives them (308′). The computing device 202 then determines whether the authorization codes 104 and 106 match (310), as has been described.

As has also been described, if the first and second authorization codes 104 and 106 match (312), the computing device 202 transmits an authorized notification to the computing device 206 (314), which receives the notification (316). The computing device 206 in turn transmits the notification to the printing device 150 (314′), which receives it (316′) and can subsequently print using the consumable item 100 (318). If the authorization codes 104 and 106 do not match (314), the computing device 202 transmits an unauthorized notification to the computing device 206 (320), which receives the notification (322). The computing device 206 in turn transmits the notification to the printing device 150 (320′), which receives it (322′) and subsequently does not print using the consumable item 100 (324).

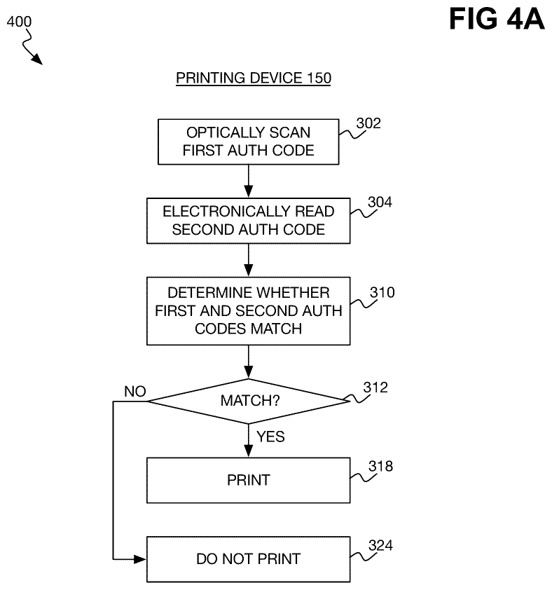

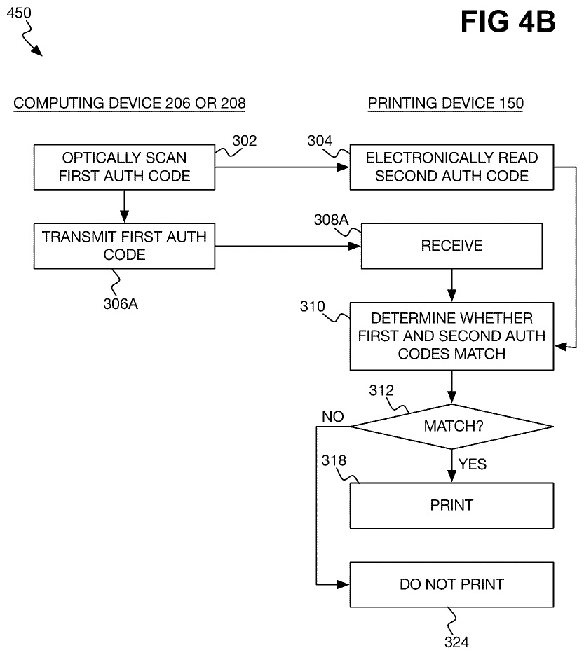

FIGS. 4A and 4B respectively show other example methods 400 and 450 for authorizing usage of the consumable item 100 within the printing device 150. As in the methods 300, 330, 340, 350, 360, and 370, such authorized usage is based on the optically scannable first authorization code 104 and the electrically readable second authorization code 106 in the methods 400 and 450. However, in the methods 400 and 450, the printing device 150, as opposed to the computing device 202, 206, or 208, determines whether the authorization codes 104 and 106 match in this respect.

Referring first to FIG. 4A, the method 400 pertains to an example in which the printing device 150 both optically scans the optically scannable first authorization code 104 and electrically reads the electrically readable second authorization code 106. The method 400 thus pertains to an implementation in which the printing device 150 is an AIO device or a MFD. That is, the method 400 pertains to an implementation in which the printing device 150 has the scanning hardware 156.

Prior to insertion of the consumable item 100 into the printing device 150, the item 100 is placed on the transparent plate of the scanning hardware 156, and the hardware 156 optically scans the optically scannable first authorization code 104 (302). If the consumable item 100 has already been inserted into the printing device 150, the item 100 is instead removed and placed on the transparent plate so that the scanning hardware 156 can optically scan the authorization code 104. Upon insertion of the consumable item 100 into the printing device 150, the authentication circuitry 154 electrically reads the electrically readable second authorization code 106 (304).

The authentication circuitry 154 then determines whether the first and second authorization codes 304 and 306 match (310). The authentication circuitry 154 may decrypt the authorization codes 304 and 306 using a symmetric cryptographic key that was used to encrypt the codes 304 and 306 and that is securely stored within the circuitry 154, and is private to the manufacturer of the printing device 150. The authentication circuitry 154 may in addition or instead verify that the first and second authorization codes 304 and 306 were digitally signed with a private cryptographic key of an asymmetric public-private key pair that is securely maintained by the manufacturer, using the public cryptographic key of the key pair. The authentication circuitry 154 may then determine whether the codes 304 and 306 are identical.

If the first and second authorization codes 304 and 306 match (312), the printing device 150 is authorized to use the consumable item 100 within the device 150. That is, the printing device 150 is permitted to and subsequently does print using the consumable item 100 (318). However, if the authorization codes 304 and 306 do not match (312), the printing device 150 is prohibited from using and is not authorized to use the consumable item 100 within the device 150. That is, the printing device 150 refrains from printing using the consumable item 100, and does not print using the item 100 (324).

Referring next to FIG. 4B, the method 450 pertains to an example in which the printing device 150 electrically reads the electrically readable second authorization code 106 and the computing device 206 or 208 optically scans the optically scannable first authorization code 104. The method 450 thus can pertain to an implementation in which the printing device 150 may be a standalone printer. In the example of FIG. 4B, the printing device 150 again determines whether the codes 104 and 106 match.

Prior to insertion of the consumable item 100 into the printing device 150, the computing device 206 or 208 optically scans the optically scannable first authorization code 104 (302). If the consumable item 100 has already been inserted into the printing device 150, the item 100 may be at least partially removed from the device 150 so that the computing device 206 or 208 can optically scan the first authorization code 104. Upon insertion of the consumable item 100 into the printing device 150, the authentication circuitry 154 electrically reads the electrically readable second authorization code 106 (304).

The computing device 206 or 208 transmits the first authorization code 104 to the printing device 150 (306A), which receives the authorization code 104 (308A). The authentication circuitry 154 then determines whether the first and second authorization codes 304 and 306 match (310), as has been described. If the first and second authorization codes 304 and 306 match (312), the printing device 150 is permitted to and subsequently does print using the consumable item 100 (318). If the authorization codes 304 and 306 do not match (312), the printing device 150 refrains from printing using the consumable item 100, and does not print using the item 100 (324).

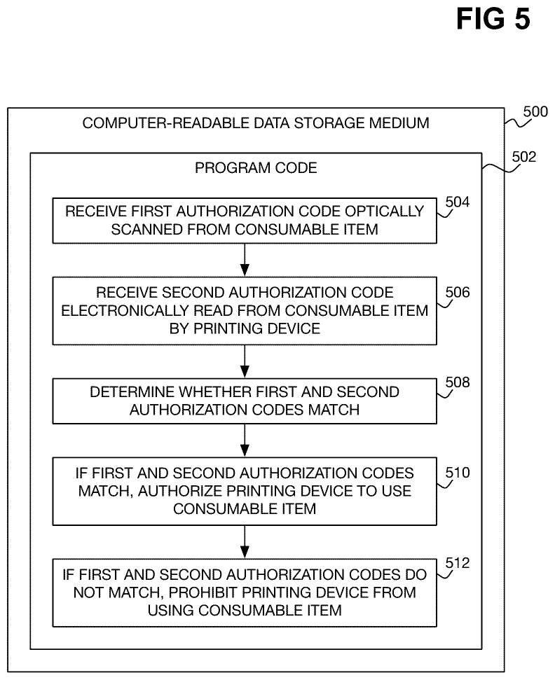

FIG. 5 shows an example non-transitory computer-readable data storage 500 medium storing program code 502 executable by a device to perform processing. The device may be the computing device 202, 206, or 208, or the printing device 150. The processing includes receiving a first authorization code 104 optically scanned from a consumable item 100 for a printing device 150 (504), and receiving a second authorization code 104 electronically read from the consumable item 100 by the printing device 150 upon insertion of the consumable item 100 into the printing device 150 (506).

The processing includes determining whether the first and second authorization codes 104 and 106 match (508). The processing includes, in response to determining that the first and second authorization codes 104 and 106 match, authorizing the printing device 150 to use the consumable item 100 for printing (510). The processing includes, in response to determining that the first and second authorization codes 104 and 106 do not match, prohibiting the printing device 150 from using the consumable item 100 for printing (512).

Techniques have been described for authorizing usage of a consumable item 100 within a printing device 150 based on both an optically readable first authorization code 104 and an electrically readable second authorization code 106 on the consumable item 100. The printing device 150 electrically reads the second authorization code 106. The printing device 150, or a computing device 206 or 208, optically scans the first authorization code 104. The printing device 150, the computing device 206 or 208, or a computing device 202 determines whether the authorization codes 104 and 106 match.

What is claimed is:

1. A non-transitory computer-readable data storage medium storing program code executable by a device to perform processing comprising:
receiving a first authorization code optically scanned from a consumable item for a printing device;
receiving a second authorization code electronically read from the consumable item by the printing device upon insertion of the consumable item into the printing device;
determining whether the first and second authorization codes match; and
in response to determining that the first and second authorization codes match, authorizing the printing device to use the consumable item for printing.

2. The non-transitory computer-readable data storage medium of claim 1, wherein the processing further comprises:
in response to determining that the first and second authorization codes do not match, prohibiting the printing device from using the consumable item for printing.

3. The non-transitory computer-readable data storage medium of claim 1, wherein the device is a computing device that receives the second authorization code from the printing device.

4. The non-transitory computer-readable data storage medium of claim 3, wherein the computing device is a first computing device,
and wherein the first computing device receives the first authorization code from the printing device:
upon the printing device optically scanning the first authorization code prior to the insertion of the consumable item into the printing device; or
upon the printing device receiving the first authorization code from a second computing device that optically scanned the first authorization code.

5. The non-transitory computer-readable data storage medium of claim 3, wherein the computing device is a first computing device,
and wherein the first computing device receives the first authorization code:
from a second computing device upon the second computing device optically scanning the first authorization code; or
by optically scanning the first authorization code.

6. The non-transitory computer-readable data storage medium of claim 3, wherein authorizing the printing device to use the consumable item for printing comprises:
transmitting a notification to the printing device that the printing device is authorized to use the consumable item for printing.

7. The non-transitory computer-readable data storage medium of claim 1, wherein the device is the printing device and receives the second authorization code by electrically reading the second authorization code upon the insertion of the consumable item into the printing device.

8. The non-transitory computer-readable data storage medium of claim 7, wherein the printing device receives the first authorization code by optically scanning the first authorization code prior to the insertion of the consumable item into the printing device.

9. The non-transitory computer-readable data storage medium of claim 7, wherein the printing device receives the first authorization code from a computing device upon the computing device optically scanning the first authorization code.

10. A printing device comprising:
printing hardware to print using a consumable item inserted into the printing device; and
authentication circuitry to:
electrically read a second authorization code on the consumable item upon insertion of the consumable item into the printing device; and
authorize the printing hardware to print using the consumable item upon a determination that the second authorization code matches a first authorization code optically scanned from the consumable item.

11. The printing device of claim 10, further comprising:
scanning hardware to optically scan the first authorization code on the consumable item prior to the insertion of the consumable item into the printing device.

12. The printing device of claim 10, wherein the authentication code is further to:
receive the first authentication code from a computing device upon the computing device optically scanning the first authentication code.

13. The printing device of claim 10, wherein the authentication circuitry is further to:
transmit the second authorization code to a computing device that performs the determination; and
receive the determination that the second authorization code matches the first authorization code from the computing device.

14. The printing device of claim 10, wherein the authentication code is further to:
perform the determination that the second authorization code matches the first authorization code.

15. A consumable item for a printing device comprising:
a housing;
a first authorization code on the housing that is optically scannable; and
a second authorization code on the housing that is electrically readable upon insertion of the consumable item into the printing device, wherein matching of the first and second authorization codes authorizes usage of the consumable item by the printing device for printing.
